(19) United States
(12) Patent Application Publication
(10) Pub. No.: US 2026/0264941 A1
(43) Pub. Date: Sep. 10, 2026

(54) PACKAGING WITH LEAK-TIGHT SNAP-FITTED CAP HOLDER

(71) Applicant: AISAPACK HOLDING SA, Vouvry (CH)

(72) Inventors: Jacques THOMASSET, Neuvecelle (FR); Joachim PELLISSIER, Fully (CH)

(21) Appl. No.: 19/164,076

(22) PCT Filed: Mar. 13, 2024
(86) PCT No.: PCT/IB2024/052410

§ 371 Date: Sep. 10, 2025

(30) Foreign Application Priority Data
Mar. 13, 2023 (EP) 23161636.8

(51) Int. Cl. B65D 41/16; B65D 35/44

(52) U.S. Cl. CPC B65D 41/165; B65D 35/44

(57) ABSTRACT

The invention relates to a packaging (1) comprising one head (2) with at least one circular snap-fitting orifice (3), a cap (6) and a cap holder (7) snap-fitted into the said snap-fitting orifice (3), wherein the snap-fitting orifice (3) comprises an annular snap-fitting zone (20) and an annular leak-tight zone (18) of different diameters, and wherein the height of the orifice (3) is greater than the thickness of the head (2), in such a way as to form a neck (14).

### CORRESPONDING APPLICATION

The present PCT application claims priority to earlier European Patent application N° EP 23161636.8 filed on Mar. 13, 2023, in the name of AISAPACK HOLDING SA, the content of the earlier application being incorporated by reference in its entirety in the present PCT application.

### TECHNICAL FIELD

The present invention relates to packaging, in particular tubes with heads which are preferably produced by moulding, for example by injection moulding or compression moulding; the moulding operation which can also be used to weld the tubular skirt to the tube head.

The invention may be applied in the field of flexible tubes intended to contain creams or pastes such as toothpaste. But the invention may of course be applied in other fields and to any other suitable packaging.

### PRIOR ART

German utility model DE 203 11 719 U1 discloses plastic tubes, specifically designed to improve the hygiene and aesthetics of tubes used to contain products such as cosmetics, toothpastes, shampoos and soaps. The tube head and cap are produced as a single integrated component. This unified design eliminates potential spaces where water could enter and stagnate, reducing the risk of germ formation and providing a more hygienic solution compared to traditional designs where the shoulder tubing and closure unit are separate components. The mould is however relatively complex to produce, which makes it difficult to customize packaging designs at a lower cost.

International patent application WO 2022/171752 describes a head for the manufacture of a flexible tube intended to contain liquid or pasty products which is characterized in that the tube head has a lid to close the neck reversibly. The tube head and the cap thus form a single component. The tube head is obtained by injection moulding and then assembled by being welded to the tube skirt. The tube head described has many advantages connected with its relatively low weight but also some disadvantages, one of them being caused by the fact that the tube head must be prefabricated, making it impossible to use this technology for the tubes manufactured by compression moulding of the head with simultaneous assembly of the skirt during the moulding operation. Another disadvantage results from the operation of assembling the injected head by welding which requires a dedicated area on the periphery for the welding, reduces the planar surface on which the tube rests and adversely affects the appearance of the tube.

European patent application EP 1 153 842 A1 proposes a series of improvements in the design of synthetic resin tubular containers, emphasizing material saving, improving closure efficiency, and optimizing utilization. Key features of the proposed enhancement include:
Integrated Design: The container is composed of a flexible tubular body and a tube head with a circumferential fixing groove for clipping an insertion cylinder connected to a lid closing the neck of the tube head.
Improved assembly: The proposal of a cylindrical clipping groove integrated into the tube head facilitates connection and reduces the need for threading.
Anti-Opening Function: The integration of an anti-opening tab attached removable to the body of the container thus improves safety against unwanted openings.
Optimized lid design: Specific configurations, such as sloped walls or improved hinge configurations, prevent the lid or parts of the container from hitting the container wall when opening.

However, despite the advantages provided, the manufacturing of those tubular containers does not significantly reduce the total mass of the head and lid. It is therefore not possible to obtain a packaging with a reduced environmental impact.

International patent application WO 2008/050264 concerns a tube that is used to dispense a fluid preparation, such as toothpaste or similar, and that has a closure device or hinged lid. This assembly includes a shoulder member that has a dispensing port, and a lid element that allows the dispensing port to be opened and closed. The shoulder member has a recess at its periphery in which an axially extending tongue of the cover member is held. The shoulder element is injection molded directly onto the dispensing end of the tube, during the manufacturing process.

The invention described in this prior art provides a solution that facilitates the use and manufacture of flexible tubing while eliminating the need for complex threaded closure systems. It requires however a very precise device to perform the operation of assembling the cover element and the shoulder member. Furthermore, there is no information showing how to significantly reduce the total mass of the lid element and the shoulder element to achieve a packaging with a reduced environmental impact.

There is therefore a need to overcome, or at least minimize, the above cited limitations.

### SUMMARY AND PRINCIPLE OF THE INVENTION

One object of the invention is to provide a packaging, which is an improvement on those which are known.

Another object of the invention is to provide a packaging in which the use of plastic materials is reduced to the maximum extent possible.

Another object of the invention is to provide a packaging containing an orifice that may be closed by a leak-tight cap.

The invention relates to a packaging, such as a tube, that comprises one head with at least one circular snap-fitting orifice, a cap and a cap holder snap-fitted into the said snap-fitting orifice, wherein the snap-fitting orifice comprises an annular snap-fitting zone and an annular leak-tight zone of different diameters, and wherein the height of the orifice is greater than the thickness of the head, in such a way as to form a neck.

According to embodiments of the invention, the cap holder contains at least one orifice for the extraction of the product contained in the packaging, the extraction orifice being smaller than the snap-fitting orifice. The cap also preferably comprises a lid, the cap holder and the lid being preferably connected to each other by a hinge. In variants, the snap-fitting orifice and the extraction orifice can be off-centre or not.

The cap holder is firmly attached to the packaging head, making it difficult or even impossible to disassemble them and causes the assembled interface to be leak-tight.

There are many advantages to the preferred embodiment, especially if the cap holder is fixed to the packaging head by hot snap-fitting. For instance, it makes it possible to reduce the assembly effort during the snap-fitting since the snap-fitting orifice has not yet contracted. Assembly whilst hot also makes it possible to absorb the dimensional variations of the cap holders.

According to some embodiments of the invention, the tube head has an excess thickness of material around the snap-fitting orifice, called a contraction ring, to increase the tightening force on the snap-fitted cap. The contraction ring is defined by the (virtual) diameter of its cross-section corresponding to the largest diameter that lies within the thickness of the packaging head close to the orifice. According to the invention, the contraction ring has a diameter which is more than 1.2 times the thickness of the wall of the packaging head; and preferably more than 1.5 times.

The invention makes it possible to manufacture a packaging which can be placed on its head. In this case, the cap is preferably recessed withing the head. To improve the stability of the packaging when it is stored vertically, it is desirable to minimize the difference between the cross-section of the packaging and the cross-section of the supporting surface. Thus, for a tube of diameter D and of a supporting surface of diameter D1, a difference D-D1 close to 0 is sought. According to the invention, this difference is less than 5 mm and preferably less than 2 mm. Of course, these values depend on the size of the tube and it is therefore the ratio between the two parameters D and D1 which must be minimized.

Preferably, the geometry of the moulded packaging head has no undercut angle. The packaging head can thus be demoulded directly by opening the mould; in other words, with no additional mechanical opening movement in an axis other than the mould opening axis. The mould thus preferably has no jaws or slides which have to be activated to release the part.

Another advantage of the invention resides in the capacity to produce a tubular packaging having a reduced proportion of plastic at the head and the cap. Thus, according to the invention, the ratio between the mass (M in grams) of the closing system (head+cap) and the mass MO of a disc of diameter D and thickness 1 mm which would close the tube is very advantageous. According to the invention, the ratio M/MO is less than 1.7; preferably less than 1.5 and advantageously less than 1.3.

According to the invention, the snap-fitted cap represents a reduced mass of material; the said mass preferably being less than that of the head. More precisely, the mass of the cap and the head are defined such that the result of the calculation (Mc/Mh)×(D/50)² is less than 1; preferably less than 0.7; and advantageously less than 0.5; Mc being the mass of the cap, Mh the mass of the head and D the diameter of the tube in mm.

Preferably the height of the snap-fitting zone is smaller than the height of the leak-tight zone.

In embodiments the snap-fitting zone and the leak-tight zone are located within the orifice.

The neck may be located within or outside from the packaging. Alternatively, a part of the neck may be located within the packaging and the other part may be located outside from the packaging.

If the neck is located outside from the packaging the snap-fitting zone may be located on the external surface of the neck. In this configuration, the height of the leak-tight zone may be equivalent to the height of the orifice.

Alternatively, if the neck is located outside from the packaging the snap-fitting zone may be located within the neck.

If the neck is located within the packaging the snap-fitting zone is preferably located within the neck.

In embodiments, the diameter of the snap-fitting zone is smaller than the diameter of the leak-tight zone. In this case the difference of diameter is preferably greater than 0.4 mm and more preferably greater than 0.5 mm.

In embodiments the diameter of the snap-fitting zone is greater than the diameter of the leak-tight zone.

Advantageously, the diameter of the cap holder leak-tight area is greater than the diameter of the leak-tight zone.

In this case, the diameter difference is preferably greater than 0.1 mm and more preferably greater than 0.2 mm.

Preferably, the ratio of the height of the leak-tight zone vs. the head thickness is greater than 1 and more preferably greater than 2.

In embodiments the snap-fitting orifice contains more than two different diameters, each diameter corresponding to an annular leak-tight or snap-fitting zone.

In embodiments the packaging comprises an annular seal located around the external side of said orifice.

The cap can also have additional or complementary snap-fitting means to reinforce the solidity of the assembly. These means can have a certain flexibility to allow them to pass inside the snap-fitting diameter.

Another advantage of the invention is the possibility of using the same cap for different packaging diameters. This is not possible with one-part cap shoulders as described in the publication WO2022/171752, for example.

The tube head may be hot or cold when the cap is snap-fitted. According to one embodiment of a process for manufacturing tubular packaging, prefabricated components are assembled; these components are, for example, a printed single-layer or multi-layer sheet, a head and a cap. The so-called “cold” components, i.e. at room temperature, are fed to an assembly machine which carries out the following successive operations:-making the tubular body by welding the edges of the sheet,
assembling the head on the end of the tubular body by welding,
clipping the cap into the shoulder hole.

According to another embodiment at least some of the components are manufactured at the same time as the packaging. This process includes, for example, at least the following steps:
manufacturing of a tubular body by extrusion or welding,
moulding of the head 2 and together overmoulding of the end of the tubular body,
clipping of the cap onto the partially cooled head,
cooling of the head.

The cross-section of the packaging according to the invention may have any suitable shape, for instance a disc, an oval, a square, oblong or polygonal.

In embodiments, the packaging is mainly plastic-based, preferably polyolefin-based and preferably polyethylene (PE)-based. According to one non-limiting method, the packaging is mainly based on high-density polyethylene (HDPE), which allows it to be recycled in the HDPE tubes and bottles sector. Alternatively, the packaging is made of polypropylene (PP), which allows recycling in the PP sector.

Depending on the method, the packaging may contain a recycled content of more than 50%, preferably more than 60% and advantageously more than 70%. In embodiments, the packaging is mainly cellulose-based, the cellulose content of the packaging being greater than 50%, advantageously above 70% and preferably above 85%. Advantageously, the packaging can be recycled in the liquid board or in the paper sector.

In embodiments, the packaging is based on bio-based materials.

In embodiments, some or all parts of the packaging (skirt, packaging head, etc) are single-layer or multi-layer or some parts are single-layer and other parts are multi-layer. In multi-layer modes, the parts can, for example, comprise a barrier layer. Examples of multi-layer structures are given in publications WO 2022/053879, WO 2022/229810, WO 2022/185176 (all incorporated by reference in their entirety in the present application) and the materials and structures described in these publications can be used to form single-layer or multi-layer structures of parts of the packaging within the scope of the present invention.

In embodiments, the packaging may comprise a skirt fixed to the packaging head.

In embodiments, the cap may comprise a lid fixed to the cap by a hinge.

In embodiments, the snap-fitting orifice may be off-centre on the packaging head.

In embodiments, the snap-fitting orifice may comprise more than two different diameters.

In embodiments, the snap-fitting orifice may comprise an excess thickness of material.

In embodiments, the packaging may comprise an insert, for instance a cellulose-based insert, overmoulded during the operation of moulding the head.

In embodiments, the insert may have a plane geometry or a varied geometry, such as a three-dimensional shape.

In embodiments, the parts of the packaging such as the skirt, the head, the cap holder, the hinge and the lid may be single-layer and/or multi-layer.

In embodiments, the invention concerns a packaging comprising one head with at least one circular snap-fitting orifice, a cap and a cap holder snap-fitted into the said snap-fitting orifice, wherein the snap-fitting orifice comprises an annular snap-fitting zone and an annular leak-tight zone of different diameters, and wherein the height of the orifice is greater than the thickness of the head, in such a way as to form a neck.

In embodiments, the height of the snap-fitting zone may be smaller than the height of the leak-tight zone.

In embodiments, the snap-fitting zone and the leak-tight zone may be located within the orifice.

In embodiments, the neck may be located within the packaging.

In embodiments, the neck may be located outside from the packaging.

In embodiments, the snap-fitting zone may be located on the external surface of the neck.

In embodiments, the height of the leak-tight zone may be equivalent to the height of the orifice.

In embodiments, the snap-fitting zone may be located within the neck.

In embodiments, the diameter of the snap-fitting zone may be smaller than the diameter of the leak-tight zone.

In embodiments, the diameter of the snap-fitting zone may be greater than the diameter of the leak-tight zone.

In embodiments, the diameter of the cap holder leak-tight area may be greater than the diameter of the leak-tight zone.

In embodiments, the diameter difference may be preferably greater than 0.1 mm and more preferably greater than 0.2 mm.

In embodiments, the height of the leak-tight zone may be greater than the height of the cap holder leak-tight area.

In embodiments, the height difference may be preferably greater than 1 mm and more preferably greater than 2 mm.

In embodiments, the snap-fitting orifice may comprise more than two different diameters.

In embodiments, the packaging may comprise an annular sealing lip located on the cap holder and a sealing zone located around the external side of said orifice; wherein the contact area between the sealing lip and the head defines the sealing zone.

In embodiments, the snap-fitting orifice may be off-centre on the packaging head.

The invention is of great interest for producing a packaging with a high proportion of cellulose, greater than 70% and preferably greater than 85%. According to embodiments of the invention, a cellulose-based skirt and a cellulose-based insert are used. According to these embodiments of the invention, when the head is moulded, the end of the skirt, as well as the insert which forms at least a part of the head, are simultaneously overmoulded. The quantity of moulded material can thus be reduced. According to these embodiments of the invention, the operation of placing the cellulose insert in the mould is performed prior to step 3 of moulding the head.

### DETAILED DESCRIPTION OF THE INVENTION

The invention will be better understood in the present chapter, with some non-limiting examples.

### REFERENCE NUMBERS AND SHORT DESCRIPTION OF THE FIGURES

1: tube
2: head
3: snap-fitting orifice
4: extremity of the tube head
5: skirt
6: cap
7: cap holder
8: lid
9: hinge
10: dispensing orifice
11: cap holder leak-tight area
12: sealing lip
13: bottom
14: neck
15: snap-fitting ring
16: cap holder leak-tight diameter
17: cap holder snap-fitting diamete
18: leak-tight zone
19: sealing zone
20: snap-fitting zone
21: orifice leak-tight diameter
22: orifice snap-fitting diameter

FIGS. 1 to 3 illustrate a first example of a packaging according to the invention.

FIGS. 4 to 6 illustrate a second example of a packaging according to the invention.

FIG. 7 illustrates an example of a cap and a cap holder according to the invention.

FIGS. 8 and 9 illustrate a third example of a packaging according to the invention.

FIGS. 10 and 11 illustrate an example of a tube according to the invention.

FIGS. 12 and 13 illustrate other examples of flexible tubes according to the invention.

FIG. 14 illustrates an example of a flask or bottle according to the invention.

As shown on several figures, the packaging 1 comprises a hinged cap 6 snap-fitted into the orifice 3 of a packaging head 2 manufactured, for example, by moulding. The cap 6 is made of a lid 8 and is linked to the cap holder 7 with a hinge 9. The head 2 is attached to a skirt 5, for example by welding of the extremity 4 of the head 2 to the skirt 5.

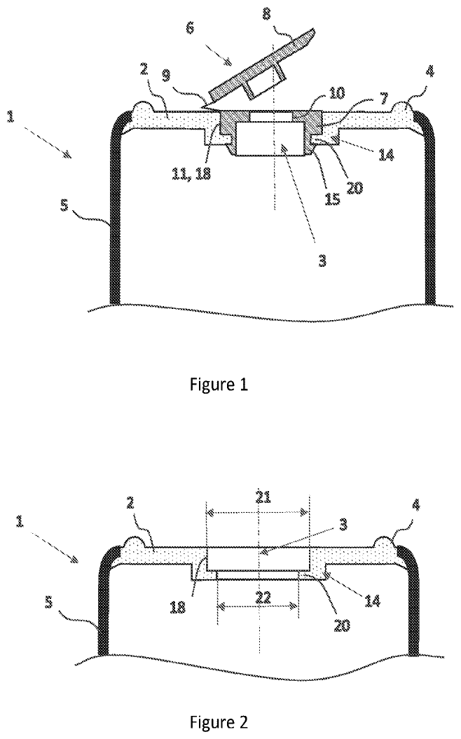

In FIG. 1, the cap holder 7 is snap-fitted within the orifice 3.

FIG. 2 shows the head 2 before the snap-fitting of the cap holder 7. The tube head 2 can be partially cooled when the snap-fitting takes place.

The orifice 3 internal wall contains an upper annular zone, named leak-tight zone 18, which provides an efficient leak-tight contact area between said leak-tight zone 18 and a cap holder area 11.

The orifice 3 internal wall furthermore contains a lower annular zone, named snap-fitting zone 20, with a smaller diameter 22 than diameter 21 of the leak-tight zone 18. The snap-fitting zone 20 provides a strong support for firmly attaching the cap holder 7 to the head 2.

The orifice 3 height, which corresponds to the addition of the height of the leak-tight zone 18 and the height of the snap-fitting zone 20, is greater than the head 2 thickness, in such a way that the height difference forms a neck 14.

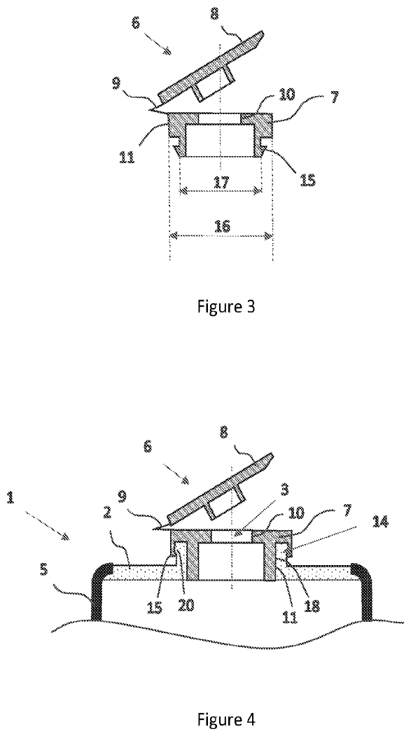

FIG. 3 shows the assembly made of the cap 6 and the cap holder 7 before the snap-fitting phase.

In the example of FIGS. 1 to 3 the neck 14 is located within the packaging 1.

The cap holder 7 contains an annular leak-tight area, named cap holder leak-tight area 11, that is configured to contact the orifice 3 leak-tight zone 18, a groove in which the snap-fitting zone 20 is inserted, and an annular snap-fitting ring 15 which prevents any accidental detachment of the cap holder 7.

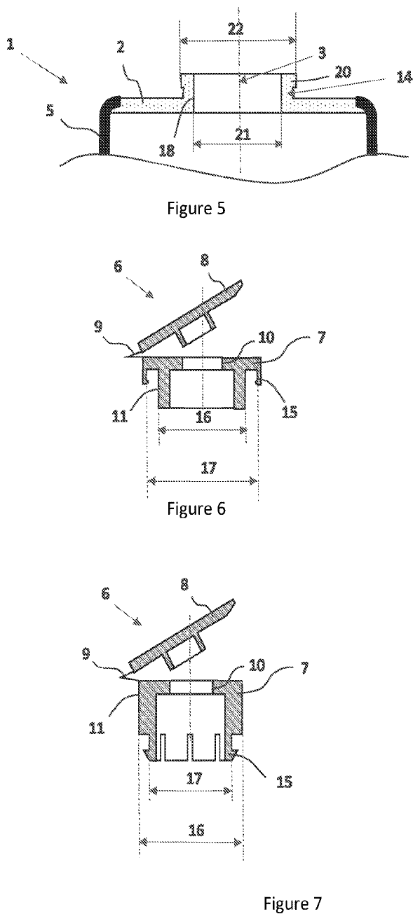

In the example of FIGS. 4 to 6 the neck 14 is located outside from the packaging 1.

In this example the snap-fitting zone 20 is located on the external surface of the neck and the height of the leak-tight zone 18 is equivalent to the orifice 3 height.

The cap holder 7 of FIG. 7 contains several flexible snap-fitting elements 15. In this case, the snap-fitting zone 20 is located within the neck 14.

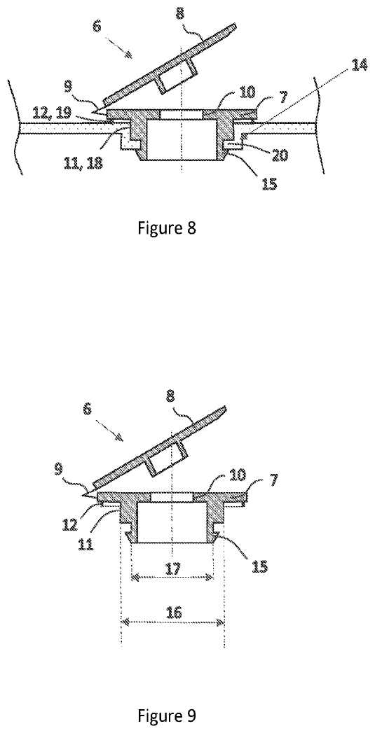

In the example of FIGS. 8 and 9 the packaging is similar to the packaging 1 of the example of FIGS. 1 to 3 but contains an additional leak-tight zone, named sealing zone 19, that is obtained by an annular sealing lip 12 located on the bottom face of the cap holder 7. The sealing lip 12 more securely interacts with the head 2.

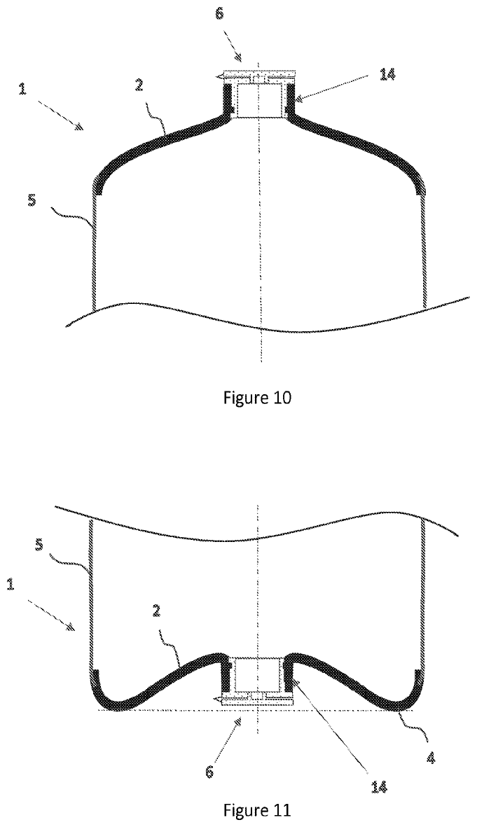

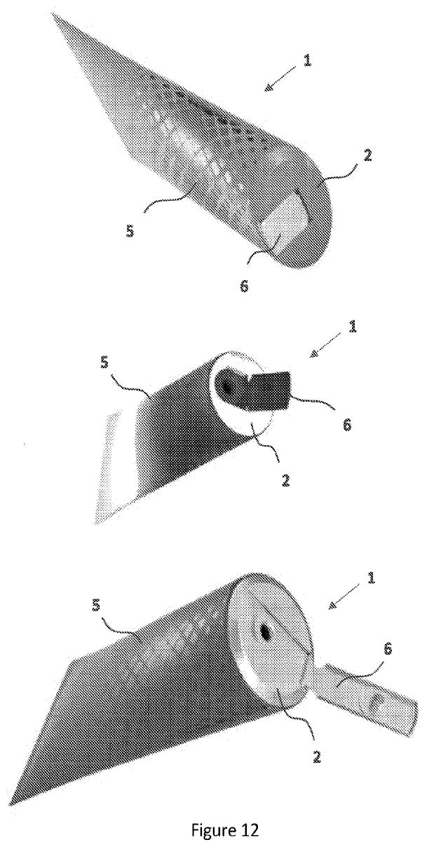

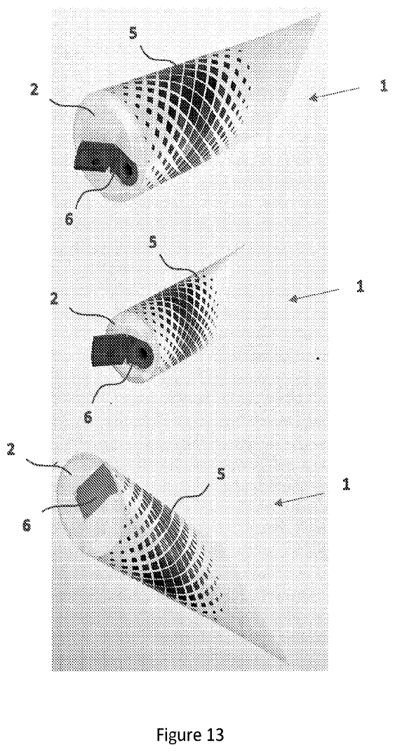

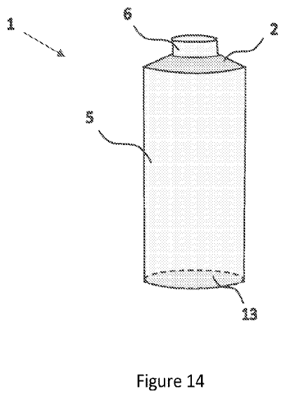

In the example of FIGS. 10 and 11 the cap holder 7 is snap-fitted in an external neck 14, with a snap-fitting zone 20 located within the neck 14.

FIG. 10 shows a packaging 1 in an active position, i.e. which allows the product extraction.

FIG. 11 shows the packaging 1 is a storage position, where the neck 14 has been retracted and where the packaging 1 is placed on its head 2.

Embodiments have been described in order to give an overall understanding of the principles of the structure, the function, the manufacture and the use of the systems and methods described in the present application. Several of these embodiments are illustrated in the drawings attached and described above. The systems and methods specifically described in the present application and illustrated in the attached drawings are non-limiting embodiments and the scope of the present invention is not defined solely by the claims. The features illustrated or described in relation to one embodiment can be combined with the features of other embodiments. Such modifications and variants are intended to be included within the scope of the present invention. A certain number of problems with the conventional methods and systems are noted here and the methods and systems described here can overcome one or more of these problems. Furthermore, whilst this invention has been described together with a certain number of embodiments, the alternatives, modifications, equivalents and variants which are within the spirit and the scope of the present invention are also covered by the present application.

1. Packaging comprising
a head including at least one circular snap-fitting orifice,
a cap and a cap holder snap-fitted into the said snap-fitting orifice,
wherein the snap-fitting orifice comprises an annular snap-fitting zone and an annular leak-tight zone of different diameters, and
wherein a height of the orifice is greater than a thickness of the head in such a way as to form a neck.

2. Packaging according to claim 1 wherein a height of the snap-fitting zone is smaller than a height of the leak-tight zone.

3. Packaging according to claim 1 wherein the snap-fitting zone and the leak-tight zone are located within the orifice.

4. Packaging according to-one claim 1 wherein the neck is located within the packaging.

5. Packaging according to claim 1 wherein the neck is located outside from the packaging.

6. Packaging according to claim 5 wherein the snap-fitting zone is located on an external surface of the neck.

7. Packaging according to claim 6 wherein a height of the leak-tight zone is equivalent to a height of the orifice

8. Packaging according to claim 5 wherein the snap-fitting zone is located within the neck.

9. Packaging according to-one claim 1 wherein the diameter of the snap-fitting zone is smaller than the diameter of the leak-tight zone.

10. Packaging according to claim 1 wherein the diameter of the snap-fitting zone is greater than the diameter of the leak-tight zone.

11. Packaging according to claim 1 wherein the a diameter of the cap holder leak-tight area is greater than the diameter of the leak-tight zone.

12. Packaging according to claim 11 wherein the diameter difference is preferably greater than 0.1 mm and more preferably greater than 0.2 mm.

13. Packaging according to claim 1 wherein the height of the leak-tight zone is greater than the a height of the cap holder leak-tight area.

14. Packaging according to claim 13 the height difference is preferably greater than 1 mm and more preferably greater than 2 mm.

15. Packaging according to claim 1 in which the snap-fitting orifice comprises more than two different diameters.

16. Packaging according to claim 1 comprising an annular sealing lip located on the cap holder and a sealing zone located around the external side of said orifice wherein the a contact area between the sealing lip and the head defines the sealing zone.

17. Packaging according to claim 1 in which the snap-fitting orifice is off-centre on the packaging head.
